(19) United States
(12) Patent Application Publication
(10) Pub. No.: US 2018/0009038 A1
(43) Pub. Date: Jan. 11, 2018

(54) METHOD FOR NANOPARTICLE PURIFICATION

(71) Applicant: FURUYA METAL CO., LTD., Tokyo (JP)

(72) Inventors: Yasuyuki Ikeda, Tokyo (JP); Tomohiro Maruko, Tokyo (JP); Masashi Takeuchi, Tokyo (JP)

(21) Appl. No.: 15/546,293

(22) PCT Filed: Feb. 23, 2016
(86) PCT No.: PCT/JP2016/055209

§ 371 Date: Jul. 26, 2017

(30) Foreign Application Priority Data
Feb. 23, 2015 (JP) 2015-032986

(51) Int. Cl. B22F 9/30; B01D 11/04; B22F 1/00; C22B 3/00

(52) U.S. Cl. CPC B22F 9/30; C22B 11/04; B01D 11/0492; B22F 1/0018

(57) ABSTRACT

A method for purifying nanoparticles by which a large amount of nanoparticles can be obtained in a safe manner and in a short time as compared to a conventional method for purifying nanoparticles. A method for purifying nanoparticles by which nanoparticles are purified from a dispersion liquid in which nanoparticles are dispersed in a solvent A used in synthesis of the nanoparticles, the method including: a mixing step of mixing the dispersion liquid, a solvent B that is miscible with the solvent A, and a solvent C that forms two phases together with the solvent B; a concentrating step of concentrating the nanoparticles in a phase of the solvent C; a washing step of forming a third phase containing the nanoparticles in the phase of the solvent C; and a purifying step of extracting the third phase and removing the solvent C from the third phase.

### BACKGROUND

### 1. Field of the Disclosure

The present disclosure relates to a method for purifying nanoparticles.

### 2. Discussion of the Background Art

A method for producing (fcc) Ru nanoparticles has been disclosed (for example, see Patent Literature 1 or Non Patent Literature 1). In addition, a method for producing Pd—Ru alloy nanoparticles has been disclosed (for example, see Patent Literature 2 or Non Patent Literature 2).

### PRIOR ART DOCUMENTS

### Patent Literature

Patent Literature 1: WO 2013/038674 A

Patent Literature 2: WO 2014/045570 A

### Non Patent Literature

Non Patent Literature 1: J. Am. Chem. Soc., 2013, 135(15), pp 5493-5496

Non Patent Literature 2: J. Am. Chem. Soc., 2014, 136(5), pp 1864-1871

### SUMMARY

Hitherto, a centrifugal separation method has been used in a method for purifying nanoparticles; however, the amount of nanoparticles to be obtained is very small against the amount of a solvent to be used. Moreover, most of solvents to be used for adjusting affinity with nanoparticles in the centrifugal separation method have a low flash point, and thus it is not suitable to handle a large amount of the solvent. As described above, by the purification method using the centrifugal separation method, a large amount of nanoparticles cannot be obtained in a safe manner and in a short time, and thus mass production of nanoparticles is not practical.

An object of the present disclosure is to provide a method for purifying nanoparticles by which a large amount of nanoparticles can be obtained in a safe manner and in a short time as compared to a conventional method for purifying nanoparticles.

### Means to Solution a Problem

A method for purifying nanoparticles according to the present invention is a method for purifying nanoparticles by which nanoparticles are purified from a dispersion liquid in which nanoparticles are dispersed in a solvent A used in synthesis of the nanoparticles, the method including: a mixing step of mixing the dispersion liquid, a solvent B that is miscible with the solvent A, and a solvent C that forms two phases together with the solvent B; a concentrating step of concentrating the nanoparticles in a phase of the solvent C; a washing step of forming a third phase containing the nanoparticles in the phase of the solvent C; and a purifying step of extracting the third phase and removing the solvent C from the third phase.

In the method for purifying nanoparticles according to the present invention, it is preferable that the washing step is a step of forming the third phase by repeating a washing cycle, which includes at least a step 1a of extracting the phase of the solvent C, a step 2a of shaking the extracted phase of the solvent C to form an concentrated phase containing the nanoparticles at a high concentration, and a step 3a of extracting the concentrated phase and mixing the concentrated phase, the solvent B, and the solvent C, and by removing the solvent A from the concentrated phase. Nanoparticles can be separated and purified without using a high speed rotating body device.

In the method for purifying nanoparticles according to the present invention, it is preferable that the washing step includes a step 1b of extracting the phase of the solvent C and a step 2b of subjecting the extracted phase of the solvent C to centrifugal separation to form the third phase, and the solvent C is non-flammable or has a flash point of 21° C. or higher. Nanoparticles can be safely separated and purified even by using a high speed rotating body device.

In the method for purifying nanoparticles according to the present invention, it is preferable that an average particle diameter of the nanoparticles is 30 nm or less. Nanoparticles suitable for a catalyst can be obtained.

In the method for purifying nanoparticles according to the present invention, it is preferable that the nanoparticles are Ru particles or Pd—Ru alloy particles. Nanoparticles suitable for a catalyst can be obtained.

In the method for purifying nanoparticles according to the present invention, it is preferable that the Ru particles have an fcc structure, and the Pd—Ru alloy particles form a solid solution. It is possible to use nanoparticles as a catalyst having higher catalytic activity.

In the method for purifying nanoparticles according to the present invention, it is preferable that the solvent B is an aqueous solvent, and the solvent C is an organic solvent that is not miscible with an aqueous solvent. Nanoparticles can be separated and purified more efficiently.

In the method for purifying nanoparticles according to the present invention, it is preferable that the organic solvent that is not miscible with an aqueous solvent is an organic solvent containing carbon and halogen as constituent elements. Nanoparticles can be separated and purified more efficiently.

In the method for purifying nanoparticles according to the present invention, it is preferable that an aqueous electrolyte is further mixed in the mixing step. Nanoparticles can be separated and purified more efficiently.

### Effects of Invention

The present disclosure can provide a method for purifying nanoparticles by which a large amount of nanoparticles can be obtained in a safe manner and in a short time as compared to a conventional method for purifying nanoparticles.

### BRIEF DESCRIPTION OF THE DRAWINGS

FIG. 1 is a TEM image of Example 1.

FIG. 2 is an XRD pattern of Example 1.

### DETAILED DESCRIPTION OF THE PREFERRED EMBODIMENT

Next, the present invention will be described in detail by means of an embodiment, but the present invention is not construed as being limited to these descriptions. As long as an effect of the present invention is exhibited, the embodiment may be variously modified.

A method for purifying nanoparticles according to this embodiment is a method for purifying nanoparticles by which nanoparticles are purified from a dispersion liquid in which nanoparticles are dispersed in a solvent A used in synthesis of the nanoparticles, the method including: a mixing step of mixing the dispersion liquid, a solvent B that is miscible with the solvent A, and a solvent C that forms two phases together with the solvent B; a concentrating step of concentrating the nanoparticles in a phase of the solvent C; a washing step of forming a third phase containing the nanoparticles in the phase of the solvent C; and a purifying step of extracting the third phase and removing the solvent C from the third phase.

First, chemicals used in the purification method will be described.

(Nanoparticles)

In this specification, nanoparticles indicate fine particles having an average particle diameter of 100 nm or less. The average particle diameter of the nanoparticles is a value calculated by measuring particle diameters of at least 100 or more particles from a particle image obtained by a transmission electron microscope (TEM) and then obtaining an average of the particle diameters. The magnification of TEM observation is, for example, preferably 150,000 times or 200,000 times. In the method for purifying nanoparticles according to this embodiment, the average particle diameter of the nanoparticles is preferably 30 nm or less. It is possible to obtain nanoparticles suitable for a catalyst. The average particle diameter of the nanoparticles is more preferably 20 nm or less. The lower limit of the average particle diameter of the nanoparticles is not particularly limited, but is preferably 1 nm or more.

The nanoparticles are, for example, metal particles such as Ru particles, Pd particles, Pt particles, Ir particles, or Au particles, or alloy particles such as Pd—Ru alloy particles. In the method for purifying nanoparticles according to this embodiment, the nanoparticles are preferably Ru particles or Pd—Ru alloy particles. It is possible to obtain nanoparticles suitable for a catalyst.

The Ru particles preferably have an fcc structure. When the Ru particles have an fcc structure, the Ru particles can be used as a catalyst having higher catalytic activity. The Ru particles having an fcc structure can be synthesized, for example, by a method described in Patent Literature 1 or Non Patent Literature 1. The crystalline structure of the Ru particles can be confirmed, for example, by an X-ray diffraction pattern (XRD pattern).

The average particle diameter of the Ru particles is preferably 30 nm or less and more preferably 10 nm or less. The lower limit of the average particle diameter of the Ru particles is not particularly limited, but is preferably 1 nm or more.

The Pd—Ru alloy particles preferably form a solid solution. The Pd—Ru alloy particles can be used as a catalyst having higher catalytic activity. More preferably, the Pd—Ru alloy particles form a single phase of the solid solution. The Pd—Ru alloy particles forming a solid solution can be synthesized, for example, by a method described in Patent Literature 2 or Non Patent Literature 2. The state of the Pd—Ru alloy particles can be confirmed, for example, by element mapping of an energy dispersive fluorescent X-ray analysis method (EDS) using scanning transmission electron microscopy (STEM). In a dissolution method, the solid solution of the Pd—Ru alloy is not formed in a case where the content of Ru in the Pd—Ru alloy particles is 10 to 90 atom %, but the solid solution of the Pd—Ru alloy can be formed by the method described in Patent Literature 2 or Non Patent Literature 2.

The average particle diameter of the Pd—Ru alloy particles is preferably 30 nm or less and more preferably 20 nm or less. The lower limit of the average particle diameter of the Pd—Ru alloy particles is not particularly limited, but is preferably 1 nm or more.

(Solvent A)

The solvent A is a solvent used in synthesis of the nanoparticles. The type of the solvent A is suitably selected according to a synthesis method of the nanoparticles and is not particularly limited in the present invention. When the synthesis method of the nanoparticles is, for example, a polyol process as described in Patent Literature 1, Non Patent Literatures 1 and 2, the solvent A is an organic solvent having 2 or more carbon atoms and reducing. The number of carbon atoms in the organic solvent is more preferably 4 or more. The upper limit of the number of carbon atoms in the organic solvent is not particularly limited, but the organic solvent is more preferably a liquid at a normal temperature.

The boiling point of the solvent A is preferably 100° C. or higher and more preferably 160° C. or higher. Thus, the solvent A is excellent in handleability. Moreover, it is possible to obtain the nanoparticles more safely. The upper limit of the boiling point of the solvent A is not particularly limited, but from the viewpoint that the solvent can be removed more easily, is preferably 300° C. or lower and more preferably 290° C. or lower.

The solvent A is preferably one or more kinds selected from polyalcohol, butanol, isobutanol, ethoxyethanol, dimethylformamide, xylene, N-methylpyrrolidinone, dichlorobenzene, toluene, propylene glycol monomethyl ether, ethylene glycol monomethyl ether, ethylene glycol monomethyl ether acetate, ethyl lactate, diethylene glycol dimethyl ether, dipropylene glycol dimethyl ether, diethylene glycol ethyl methyl ether, diethylene glycol isopropyl methyl ether, dipropylene glycol monomethyl ether, diethylene glycol diethyl ether, diethylene glycol monomethyl ether, diethylene glycol butyl methyl ether, tripropylene glycol dimethyl ether, triethylene glycol dimethyl ether, diethylene glycol monobutyl ether, ethylene glycol monophenyl ether, triethylene glycol monomethyl ether, diethylene glycol dibutyl ether, triethylene glycol butyl methyl ether, polyethylene glycol dimethyl ether, tetraethylene glycol dimethyl ether, and polyethylene glycol monomethyl ether. Among these, from the viewpoint that the nanoparticles can be obtained more safely and more efficiently, polyalcohol is more preferable.

Polyalcohol is preferably one or more kinds selected from ethylene glycol, diethylene glycol, triethylene glycol, propylene glycol, and butylene glycol. Among these, triethylene glycol (TEG) is more preferable. It is possible to obtain the nanoparticles more safely and more efficiently.

(Dispersion Liquid)

The dispersion liquid is a reaction solution after synthesis of the nanoparticles. For example, when the nanoparticles are Ru particles and the synthesis method of the Ru particles is the method of Patent Literature 1 or Non Patent Literature 1, the dispersion liquid contains the Ru particles, polyvinylpyrrolidone (PVP), and TEG. In addition, when the nanoparticles are Pd—Ru alloy particles and the synthesis method of the Pd—Ru alloy particles is the method of Non Patent Literature 2, the dispersion liquid contains the Pd—Ru alloy particles, polyvinylpyrrolidone (PVP), and TEG.

(Solvent B)

The solvent B is preferably an aqueous solvent. The solvent B is, for example, water or saturated saline. Of these, from the viewpoint of having excellent handleability and a high miscibility with the solvent A, the solvent B is more preferably water.

(Solvent C)

The solvent C is preferably an organic solvent that is not miscible with an aqueous solvent. The organic solvent that is not miscible with an aqueous solvent is preferably an organic solvent containing carbon and halogen as constituent elements. The solvent C is, for example, chloroform, dichloromethane, or carbon tetrachloride. Of these, from the viewpoint of having excellent handleability, the solvent C is more preferably chloroform. When the solvent B is an aqueous solvent and the solvent C is an organic solvent that is not miscible with an aqueous solvent, the solvent B and the solvent C form two phases, and thus the nanoparticles can be separated and purified more efficiently.

Next, each step of the purification method will be described.

(Mixing Step)

In the mixing step, the dispersion liquid, the solvent B, and the solvent C are mixed to prepare a mixed solution. In the present invention, the addition order of respective chemicals is not particularly limited. The used amounts of the solvent B and the solvent C are not particularly limited.

In the method for purifying nanoparticles according to this embodiment, it is preferable to further mix an aqueous electrolyte in the mixing step. Since the solvent A may have a function of increasing miscibility of the solvent B and the solvent C, when the aqueous electrolyte is mixed, the polarity of the solvent B is increased so that separability between the solvent B and the solvent C can be improved. As a result, it is possible to separate and purify the nanoparticles more efficiently. The aqueous electrolyte is, for example, potassium chloride, sodium chloride, calcium carbonate, or ammonium carbonate.

(Concentrating Step)

The concentrating step is preferably a step in which the mixed solution obtained in the mixing step is shaken and then left to stand still. Through the concentrating step, the mixed solution forms two phases composed of a phase of the solvent B and a phase of the solvent C. For example, when the solvent B is water and the solvent C is chloroform, the phase of the solvent B (water phase) is an upper phase and the phase of the solvent C (organic phase) is a lower phase. The nanoparticles are concentrated in the phase of the solvent C. In addition, the solvent A is miscible with both the phase of the solvent B and the phase of the solvent C, but it is preferable that the solvent A be more miscible with the phase of the solvent B. It is possible to separate and purify the nanoparticles more efficiently.

(Washing Step)

In the washing step, a washing method is not particularly limited as long as the third phase containing the nanoparticles can be formed in the phase of the solvent C. A method of forming the third phase containing the nanoparticles in the phase of the solvent C is, for example, a method of applying a solvent extraction method to solid-liquid separation, a centrifugal separation method, or a flotation method. Of these, from the viewpoint that the nanoparticles can be separated and purified relatively simply without using a high speed rotating body device, a method of applying a solvent extraction method to solid-liquid separation is more preferable.

An example in which a method of applying a solvent extraction method to solid-liquid separation is employed will be described as an example of the washing step. The washing step is preferably a step of forming the third phase by repeating a washing cycle, which includes at least a step 1a of extracting the phase of the solvent C, a step 2a of shaking the extracted phase of the solvent C to form an concentrated phase containing the nanoparticles at a high concentration, and a step 3a of extracting the concentrated phase and mixing the concentrated phase, the solvent B, and the solvent C, and by removing the solvent A from the concentrated phase.

In the step 1a, only the phase of the solvent C is extracted from the mixed solution undergoing the concentrating step.

In the step 2a, the phase of the solvent C extracted in the step 1a is shaken. Thereafter, when the phase of the solvent C is left to stand still, an concentrated phase is formed in the phase of the solvent C. The concentrated phase is a phase in which the nanoparticles are dispersed in the solvent C at a high concentration. A boundary between the concentrated phase and the phase of the solvent C other than the concentrated phase can be visually recognized by a difference in color density. In the step 2a, the solvent B is incorporated into both the concentrated phase and the phase of the solvent C other than the concentrated phase, but it is preferable that the solvent B be incorporated much more into the phase of the solvent C other than the concentrated phase. It is possible to separate and purify the nanoparticles more efficiently.

In the step 3a, only the concentrated phase is extracted from the phase of the solvent C undergoing the step 2a. Then, the solvent B and the solvent C are newly mixed with the extracted concentrated phase to prepare a mixed solution. For example, when this mixed solution is shaken and then left to stand still, two phases composed of the phase of the solvent B and the phase of the solvent C are formed. At this time, a foam-like phase is formed in the phase of the solvent C. The foam-like phase is formed by moving a trace amount of the solvent A and the nanoparticles into the solvent C when the solvent A is miscible in the solvent C.

When the washing cycle including at least the steps 1a to 3a is repeated, the phase of the solvent C is divided into two phases in the step 3a to generate a foam-like third phase. This third phase contains the nanoparticles at a high concentration and does not contain the solvent A. In addition, as the washing cycle is repeated, the concentration of PVP in the phase of the solvent C decreases. The mechanism in which the third phase is generated in the step 3a will be described. As the washing cycle is repeatedly performed, the concentration of the nanoparticles in the phase of the solvent C in the step 3a increases and the concentration of the solvent A in the phase of the solvent C decreases. In the washing cycle at the initial stage, since the solvent A is present in the phase of the solvent C, the nanoparticles are entirely dispersed in the phase of the solvent C in a state where the nanoparticles are dispersed in the solvent A. For this reason, a clear boundary between the foam-like phase formed in the step 3a and the phase of the solvent C other than the foam-like phase is not recognized. When most parts of the solvent A are removed from the phase of the solvent C by repeating the washing cycle, the nanoparticles cannot be dispersed in the solvent C and the nanoparticles are attached to bubbles in the foam-like phase to form the third phase in the upper part of the phase of the solvent C. As a result, most parts of the nanoparticles are incorporated into the foam-like phase. When the solvent B is water and the solvent C is chloroform, the third phase becomes an intermediate phase generated at a boundary portion between the phase of the solvent B and a phase of the solvent C.

The washing cycle is terminated when the foam-like third phase is generated in the step 3a. Since the foam-like third phase contains the nanoparticles at a high concentration, the foam-like third phase is colored with black while the phase present below the foam-like third phase is almost transparent, and thus it can be confirmed that the phase of the solvent C is divided into two phases.

An example in which the centrifugal separation method is employed will be described as another example of the washing step. It is preferable that the washing step include a step 1b of extracting the phase of the solvent C and a step 2b of subjecting the extracted phase of the solvent C to centrifugal separation to form the third phase, and the solvent C is non-flammable or has a flash point of 21° C. or higher.

In the step 1b, only the phase of the solvent C is extracted from the mixed solution undergoing the concentrating step.

In the step 2b, the phase of the solvent C extracted in the step 1b is subjected to centrifugal separation.

When the washing step is performed by a centrifugal separation method, the solvent C is preferably a solvent that is non-flammable or has a flash point of 21° C. or higher among solvents exemplified as the solvent C. It is possible to safely separate and purify the nanoparticles even by using a high speed rotating body device. A non-flammable solvent is, for example, chloroform, dichloromethane, or carbon tetrachloride. In addition, a solvent having a flash point of 21° C. or higher is, for example, ethyl acetate. Of these, a non-flammable solvent is preferable, and chloroform is more preferable.

When a flotation method is employed as the washing step, only the phase of the solvent C is extracted from the mixed solution undergoing the concentrating step and a foaming agent is added to the extracted phase of the solvent C and then stirred. By doing this, the nanoparticles are attached to the surfaces of bubbles. The bubbles attached with the nanoparticles gather in the upper part of the phase of the solvent C to form the third phase. Known foaming agents can be used as the foaming agent and the foaming agent is suitably selected according to the type of the nanoparticles or the type of the solvent A.

(Purifying Step)

The purifying step is to extract the third phase formed in the washing step from the phase of the solvent C and remove the solvent C from the third phase. A method of removing the solvent C is not particularly limited, but is, for example, a reduced-pressure distillation method using an evaporator, a distillation column, or the like, a heat drying method, or a freeze drying method.

The purification method according to this embodiment can purify a large amount of nanoparticles at one time; on the other hand, when the same mass of nanoparticles is intended to be purified by the purification method using a centrifugal separation method of the prior art, plural times of purification processes are required. As a result, the purification method according to this embodiment can obtain a larger amount of nanoparticles in a short time as compared to the purification method using a centrifugal separation method of the prior art.

### EXAMPLES

Hereinafter, the present invention will be described in more detail by means of Examples, but the present invention is not construed as being limited to Examples.

### Example 1

500 mL of triethylene glycol (hereinafter, TEG) (solvent A) was put into a flask. 7.9681 g (20 mmol) of tris(acetylacetonato)ruthenium (III) (hereinafter, Ru(acac)₃) and 1.11 g of polyvinylpyrrolidone (hereinafter, PVP) were weighed and then added into the TEG to prepare a solution (hereinafter, solution A). The solution A was heated such that the temperature of the solution A reached 200° C. or higher, and the solution A was heated with stirring for 3 hr after heating and then cooled to obtain a dispersion liquid in which Ru particles are dispersed in the TEG. A mixed solution obtained by adding 1,500 mL of chloroform (solvent C) and 1,000 mL of pure water (solvent B) to the dispersion liquid was prepared (a mixing step), and the mixed solution was left to stand still for a while. This mixed solution was quartered, 500 mL of chloroform was further added to the quartered mixed solutions respectively, the resultant solutions were shaken to be divided into two phases of a water phase and an organic phase, and then Ru particles were extracted in the organic phase (concentrating step). Thereafter, only the organic phase was extracted (washing step 1a), and the organic phase excluding the water phase was shaken again to form an concentrated phase of nanoparticles in the upper part of the organic phase (washing step 2a). Then, only the concentrated phase was extracted, 500 mL of chloroform and 500 mL of pure water were newly added to the extracted concentrated phase, the resultant solution was shaken again to be divided into two phases of a water phase and an organic phase, and then Ru particles were extracted in the organic phase (washing step 3a). The washing steps 1a to 3a were repeated until an concentrated phase of nanoparticles was formed as an intermediate phase (third phase) between the water phase and the organic phase, and the obtained concentrated phase was concentrated and dried to thereby obtain Ru particles as solids (purifying step). The yield was 1.9360 g.

### Example 2

500 mL of pure water was put into a flask. 1.2116 g of ruthenium chloride (III) n-hydrate (RuCl₃.nH₂O) (Ru: 5 mmol) and 1.6411 g of potassium tetrachloropalladate (II) (K₂PdCl₄) (Pd: 5 mmol) were weighed and then added to the pure water to prepare an aqueous solution containing a Ru compound and a Pd compound. In addition, 300 mL of TEG was put into a beaker. 0.3376 g of PVP was weighed and then added to the TEG to prepare a suspended TEG solution, and then the TEG solution was heated to 205° C. After the aqueous solution containing a Ru compound and a Pd compound was added in a form of mist to the heated TEG solution, the resultant solution was heated and held for 10 min and then cooled to obtain a dispersion liquid in which Pd—Ru alloy particles are dispersed in the TEG. 700 mL of chloroform and 700 mL of pure water were mixed in this dispersion liquid to prepare a mixed solution (mixing step). The mixed solution was shaken to be divided into two phases of a water phase and an organic phase so that the Pd—Ru alloy particles were extracted in the organic phase (concentrating step). Thereafter, only the organic phase was extracted (washing step 1a) and the organic phase excluding the water phase was shaken again to form an concentrated phase of nanoparticles in the upper part of the organic phase (washing step 2a). Then, only the concentrated phase was extracted, 500 mL of chloroform and 500 mL of pure water were newly added to the extracted concentrated phase, the resultant solution was shaken again to be divided into two phases of a water phase and an organic phase, and then Pd—Ru alloy particles were extracted in the organic phase (washing step 3a). The washing steps 1a to 3a were repeated until an concentrated phase of nanoparticles was formed as an intermediate phase (third phase) between the water phase and the organic phase, and the obtained concentrated phase was concentrated and dried to thereby obtain Pd—Ru alloy particles as solids (purifying step). The yield was 0.79 g.

(Average Particle Diameter of Ru Particles)

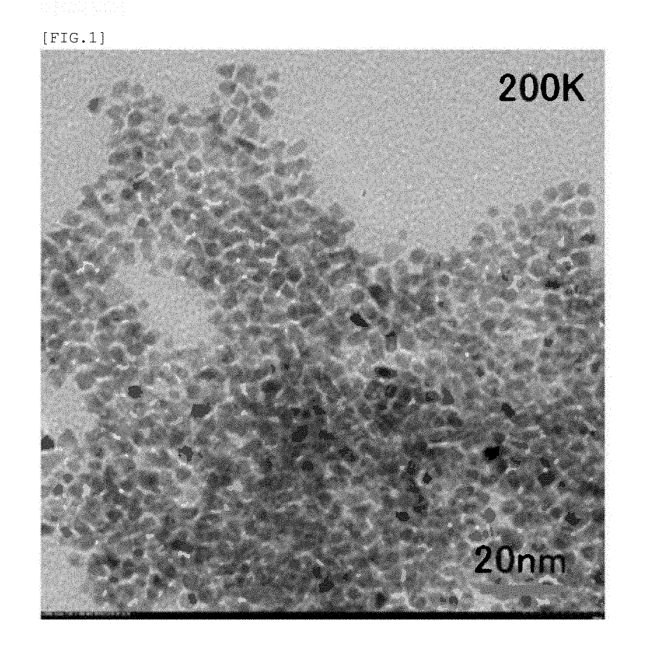

The Ru particles of Example 1 were observed with a TEM at a magnification of 200,000 times, the particle diameters of 100 particles were measured from the obtained particle image, and then an average of the particle diameters was obtained as the average particle diameter of the Ru particles. FIG. 1 shows a TEM image of Example 1. The average particle diameter of Example 1 was 3.27 nm.

(Crystalline State)

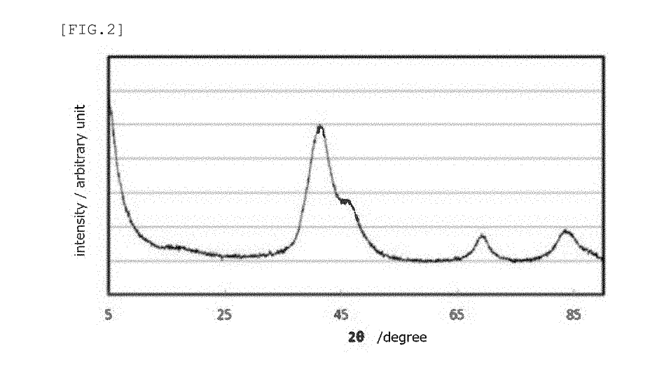

XRD measurement was performed on the Ru particles of Example 1. The XRD measurement conditions include room temperature and μ=CuKα. FIG. 2 shows an XRD pattern of Example 1. In FIG. 2, the pattern of Ru indicates the pattern of (fcc) Ru and it can be confirmed that the Ru particles have an fcc structure. A certain quantity of the pattern derived from PVP was confirmed near 20°. It was found that the remained amount of PVP was the same level as in the purification method using a centrifugal separation method of the prior art.

What is claimed is:

1. A method for purifying nanoparticles by which nanoparticles are purified from a dispersion liquid in which nanoparticles are dispersed in a solvent A used in synthesis of the nanoparticles, the method comprising:
a mixing step of mixing the dispersion liquid, a solvent B that is miscible with the solvent A, and a solvent C that forms two phases together with the solvent B;
a concentrating step of concentrating the nanoparticles in a phase of the solvent C;
a washing step of forming a third phase containing the nanoparticles in the phase of the solvent C; and
a purifying step of extracting the third phase and removing the solvent C from the third phase.

2. The method for purifying nanoparticles according to claim 1, wherein the washing step is a step of forming the third phase by repeating a washing cycle, which includes at least a step 1a of extracting the phase of the solvent C, a step 2a of shaking the extracted phase of the solvent C to form an concentrated phase containing the nanoparticles at a high concentration, and a step 3a of extracting the concentrated phase and mixing the concentrated phase, the solvent B, and the solvent C, and by removing the solvent A from the concentrated phase.

3. The method for purifying nanoparticles according to claim 1, wherein the washing step includes a step 1b of extracting the phase of the solvent C and a step 2b of subjecting the extracted phase of the solvent C to centrifugal separation to form the third phase, and
the solvent C is non-flammable or has a flash point of 21° C. or higher.

4. The method for purifying nanoparticles according to claim 1, wherein an average particle diameter of the nanoparticles is 30 nm or less.

5. The method for purifying nanoparticles according to claim 1, wherein the nanoparticles are Ru particles or Pd—Ru alloy particles.

6. The method for purifying nanoparticles according to claim 5, wherein the Ru particles have an fcc structure, and
the Pd—Ru alloy particles form a solid solution.

7. The method for purifying nanoparticles according to claim 1, wherein the solvent B is an aqueous solvent, and
the solvent C is an organic solvent that is not miscible with an aqueous solvent.

8. The method for purifying nanoparticles according to claim 7, wherein the organic solvent that is not miscible with an aqueous solvent is an organic solvent containing carbon and halogen as constituent elements.

9. The method for purifying nanoparticles according to claim 1, wherein an aqueous electrolyte is further mixed in the mixing step.
